(19) United States
(12) Patent Application Publication
(10) Pub. No.: US 2004/0022378 A1
(43) Pub. Date: Feb. 5, 2004

(54) TELEPHONE BILLING METHOD

(76) Inventors: STANLEY KUGELL, NEWTON CENTER, MA (US); DAVID SILVER, CAMBRIDGE, MA (US)

Correspondence Address: CLIFFORD CHANCE US LLP, 200 PARK AVENUE, NEW YORK, NY, 10166, US

(21) Appl. No.: 08/554,533

(22) Filed: Nov. 6, 1995

Related U.S. Application Data
(63) Continuation of application No. 08/141,989, filed on Oct. 28, 1993, now abandoned.
Application No. 08/141,989 is a continuation of application No. 08/113,628, filed on Aug. 31, 1993, now abandoned.

(51) Int. Cl. H04M 15/00; H04M 17/00

(52) U.S. Cl. 379/144.01; 379/112.01; 379/114.01

(57) ABSTRACT

A method of billing a collect telephone call comprising providing a toll-free or a local telephone number to a customer to access a provider in a toll-free call from a calling party telephone number; receiving the originating telephone number in response to the toll-free call; obtaining a destination telephone number from the customer; billing the call to the destination telephone number as coming from a predetermined other telephone number, whereby the calling party telephone number is not provided to the destination telephone number. Alternately, when a toll-free number is provided, billing the call to the destination telephone number as coming from the calling party telephone number.

### BACKGROUND OF THE INVENTION

This invention relates to a method of telephone billing.

In the present mode of making a collect-call telephone call, a caller accesses a telephone system by dialing the telephone number to be called with a prefix, for example the so-called zero plus (0+) prefix, which places the call under the control of a human or automatic operator. When the call is connected, the telephone number of the caller (the originating number) is provided to the telephone company central switching office associated with the called number for billing purposes. This originating telephone number typically appears on the bill of the called number along with other information, for example, the date, time, and duration of the call.

In many instances it is undesirable or unsafe for a called party at the destination to know the originating number. Presently the originating number is always transmitted and becomes a part of the called party's (the destination's) billing record.

The proliferation of multiple telephone service providers (such as independent long distance carriers) having multiple rates of service has made it difficult, and sometimes impossible, for telephone callers wishing to make collect calls to use a provider of their choice. For example, some callers in a hotel are forced to use the provider connected to the hotel's telephone system, and that provider may not provide the user with an optimal or acceptable rate for the service. Furthermore, many establishments do not provide free telephone service, even for calls billed to other numbers.

### SUMMARY OF THE INVENTION

In general this invention provides a method of billing a collect telephone call. The method comprises providing a toll-free or local telephone number to a caller to access a service provider in a toll-free call from a calling party telephone number; receiving the originating telephone number in response to the toll-free or local call; obtaining a destination number for a party to be called from the customer; and billing the call to the destination number as coming from a predetermined other telephone number, whereby the calling party's telephone number is not provided to the destination number. Thus, according to this invention a customer initiates a collect call to a called party at a destination number by calling a toll-free telephone number or a local telephone number.

In one preferred embodiment the customer's telephone number is not provided to the destination during billing, instead, the call is billed to the destination as from another telephone number.

In another preferred embodiment, the invention features a method of billing a collect telephone call comprising providing a toll-free or local number to a customer to access a provider in a toll-free or local call from a calling party telephone number; receiving the originating telephone number in response to the toll-free or local call; obtaining a destination number of a party to be called from the customer; and billing the call to the destination number as coming from the calling party telephone number.

In another preferred embodiment the invention features a method of billing a collect telephone call comprising providing a toll-free or local number to a customer to access a provider in a toll-free or local call from a calling party telephone number; receiving the originating telephone number in response to the toll-free or local call; obtaining a destination of a party to be called number from the customer; receiving customer identification information from the customer; calling the destination number; providing the customer identification information to a party answering the destination number; accepting a response from the party as to whether the collect call will be accepted; based on the response, in the event that the response is affirmative, connecting the calling party telephone number and the destination number; and billing the call to the destination number as coming from a predetermined other telephone number, whereby the calling party telephone number is not provided to the destination number.

In other preferred embodiments, the invention further comprises receiving customer identification information from the customer; calling the destination number; providing the customer identification information to a party answering the destination number; accepting a response from the party as to whether the collect call will be accepted; based on the response, in the event that the response is affirmative, connecting the calling party telephone number and the destination number.

In one embodiment of the invention the steps of obtaining the destination and receiving the customer identification are performed by a human operator. In another embodiment of this invention the step of obtaining the destination is performed in response to pressing at least one key on the customer's telephone, and the step of receiving the customer information is performed by recording information, for example, the customer's name, provided by the customer.

In one embodiment of the invention, the steps of providing the customer identification and connecting the telephone numbers are performed by a human operator. In another embodiment, a recording of the customer identification information is used in the step of providing to give the customer identification information to the called party, and the step of connecting is performed in response to pressing at least one key on a destination telephone.

In some embodiments the predetermined other telephone number is a telephone number of the provider. When that number is called either an operator or a recording informs the caller that the calling party telephone number is not available.

In some embodiments a temporary muted connection is established between the calling party and the called party at the destination until the connection is established. one advantage of this invention is that, by not providing the originating telephone number to the called party at the destination, the phone number (and thus the location) of the caller remains unknown, thereby affording the caller privacy and protection.

Another advantage of this invention is that a caller is provided with a toll-free number from which to place collect calls, thereby permitting use of the system from telephones at multiple locations without concern for the costs or billing practices of the systems to which those telephones are connected.

Other provides and advantages will become apparent from the following description of the preferred embodiments and from the claims.

### BRIEF DESCRIPTION OF THE DRAWING

FIG. 1 is a block diagram of a system for performing the method according to this invention.

FIGS. 2-4 are flow charts of embodiments of the method according to this invention.

### DESCRIPTION OF THE PREFERRED EMBODIMENTS

Referring to FIG. 1, a method for telephone billing according to the invention preferably is implemented using a customer telephone instrument 20a which is connected by conventional cabling 2 to a telephone company central office 30a. The central office is equipped with conventional caller-identification circuitry 31a. The telephone instrument 20a may be a touch-tone dual-tone multifrequency (DTMF) telephone instrument.

The central office 30a is connected to a service provider 40 over a conventional inter-office trunk 4. In general, a service provider is a telephone company that provides telephone connection, operator assistance, billing, etc. Examples of service providers include long distance telephone carriers. Service provider 40 has a provider computer 46 connected to equipment including DTMF decoder 42 and message recorder and playback system 44. Provider computer 46 performs billing functions to bill customers for billable calls such as collect calls, and to bill receiving parties for toll-free calls such as 800 calls.

Note that the caller's central office 30a and the destination's central office 30b may be the same central office and that a third instrument 20c may be the called party instrument.

As shown in FIGS. 2-4, the method of this invention includes placing, at step 10, a toll-free call (for example, an 800 call) or a local call to a destination using customer instrument 20a. Placing the call effects the receipt of the customer's telephone number, the originating telephone number, by central office 30a, at step 12.

The caller's telephone number and other information are sent from the central office 30a to the provider 40, at step 14. The provider 40 then interacts with the customer, at steps 16-18, either via a human operator or using an automated system on provider computer 46 (or a combination of human and automated interaction) to obtain the number to be called (the destination number) and customer identification information.

The customer/operator interaction can take a number of forms, depending on the degree of automation at the provider. In one case, a human operator asks the customer for the destination number (i.e., the number to be called), and the customer's name. In this case the customer's name is to be used as the customer identification information.

In another case, a recorded message from the provider asks the customer to enter the destination number using the buttons on telephone instrument 20a. This number is captured using the DTMF decoder 42. Then a second recorded message from the provider asks for the customer's name (to be used as the customer identification information). The customer's response to this query is recorded by the recorder 44.

Combinations of the first and second cases can be used, for example, a human operator can obtain the destination number from the customer and a recorder can be used to obtain the customer's name.

As an example, a recorded message from the provider may state “Please enter the number you wish to call.” At that point the customer enters the destination number using the buttons on the telephone instrument. Once the number has been correctly entered a second recorded message may announce “Please state your name.” The recorder 44 at the provider 40 then records a response from the caller. The provider may use a voice-activation system to ensure that something is said in response to the second message. If nothing is said then the provider may try again to get the customer's name or may terminate the call.

The customer may provide the destination number using keys on customer instrument 20a which the provider obtains using DTMF decoder 42. The provider may record the customer identification information on the recorder and playback device 44.

Once the provider 40 has obtained sufficient information to proceed, the provider calls the destination number, at step 20. If a party at the destination answers the call, using the destination instrument 20b, the provider provides the destination with the customer identification information, at step 22, and accepts a response from the destination as to whether or not the collect call will be accepted, at step 24.

The provider may provide the information to the destination using a human operator or via an automated system. For example, the provider may play back the previously recorded customer identification information to the destination using recorder and playback device 44. The provider may accept the destination's response using touch-tone decoder 42. For example, the destination may be told to press the “1” key on destination instrument 20b if the call is accepted, or hang up the destination instrument 20b if the call is not accepted.

For example, suppose that, in response to the message “Please state your name.”, the customer says “John Doe”, which is then recorded on recorder 44. When the destination number answers the call, the provider plays the message “You have a collect call from John Doe. Will you accept the call? Press ‘1’ to accept the call or hang up to reject the call”.

The provider can deal with incorrect or invalid responses from the called party in a number of ways. In one case the provider can repeat the message and give the called party another chances to respond correctly. In another case the provider can terminate the call. In cases where the called party does not accept the call, the provider can inform the caller or can terminate the call. For example, if the called party hangs up to reject a call, the provider can play a recording to the caller such as “The party at x did not accept a collect call from y”, where the destination number is stated at x and the caller's identification information is stated at y. Thus, the message may say “The party at 555-1234 did not accept a collect call from John Doe”.

If the provider 40 determines, at step 26, that the party at the destination will not accept the call, then the provider disconnects the call from the destination and the caller.

In one embodiment, as shown in FIG. 3, if the provider determines, at step 26, that the destination will accept the call, then the caller and the destination are connected, and computer 46 at provider 40 is given the caller's telephone number (the originating number) for printing on the bill or for passing to a billing service or another central office at some later time.

Referring to FIG. 1, when a customer places a call to a number using a customer instrument 20a, the customer's central office 30a (the local CO) obtains the customer's phone number as well as the phone number called. From the customer's phone number, the customer's central office obtains the customer's billing number from a database (not shown) accessed by a computer at the customer's central office (the local CO)). The customer's billing number may or may not be the same as the customer's phone number. The customer's local CO 30a then passes the billing number and parts of the dialed number to the provider 40. (Some parts of the dialed number, for example, the first digit “1” may be stripped off by the local CO before the number is sent to the provider.) The provider 40 then determines, by accessing a database via computer 46, the actual phone number corresponding to the toll-free number dialed. The provider 40 stores the customer's billing number and routes the call to the actual phone number via its central office 30b (the called CO) When a party answers the call, at the called party instrument 20b, the called CO sends a signal to the provider computer 40 which then connects the caller with the called party and begins timing the call. When either party hangs up that party's central office signals the provider computer 46 that the call is terminated and the provider stops timing the call. Then the time of the call and the customer's billing number are written to a billing tape (not shown) for later billing. Typically the tape is processed on a monthly basis by a separate billing institution. In the case of a toll-free or “800” call the call is billed to the actual phone number (person accepting call), listing the call as coming from the customer's billing number rather than the phone number from which the phone call was place.

In another distinct embodiment, as shown in FIG. 4, if the provider determines, at step 26, that the destination will accept the call, then the caller and the destination are connected, and computer 46 at the provider 40, is given a third telephone number (not the originating number) for billing purposes. Referring to the discussion on billing above, in this embodiment, in the case of a toll-free or “800” call, the call is billed to the actual phone number, listing the call as coming from a third telephone number, not the customer's billing number.

This third telephone number may be one allocated by the provider. In some embodiments, if the third telephone number is called, the caller will be given no information about the call, merely a message that a call was made. If other embodiments the caller will be given some information about the call, but not the originating number.

For example, upon receipt of a bill, a caller will determine that a collect call was made, ostensibly from the third number. When calling that number the caller (who was the called party in the earlier scenario) hears a recorded message, for example,

“You have reached 555-4321. If this number is on a phone bill, that indicates that the party making a call did not wish his or her number to be known. That party's number is not available.”

In some embodiments the provider will retain records about a call, including the originating number and the caller's identification information. A caller to the third telephone number may be given some of this information. In these cases the information can be provided to the caller by a human operator or via an interactive automated system.

In some preferred embodiments, while the provider is interacting with the destination as to whether or not the call will be accepted (at steps 22-26), the caller is able to hear the interaction, but is muted, thereby preventing the destination from hearing anything that the caller says.

Other embodiments are within the following claims.

What is claimed is:

1. A method of telephone billing a collect call comprising the steps of:
providing a toll-free telephone number to a customer to access a provider in a toll-free call from a calling party telephone number;
receiving the originating telephone number in response to the toll-free call;
obtaining destination telephone number from the customer;
billing th call to the destination telephone number as coming from a predetermined other telephone number, whereby the calling party telephone number is not provided to the destination telephone number.

2. A method of telephone billing a collect call comprising the steps of:
providing a toll-free telephone number to a customer to access a provider in a toll-free call from a calling party telephone number;
receiving the originating telephone number in response to the toll-free call;
obtaining a destination telephone number from the customer;
billing the call to the destination telephone number as coming from the calling party telephone number.

3. A method of telephone billing a collect call comprising the steps of:
providing a local telephone number to a customer to access a provider in a call from a calling party telephone number;
receiving the originating telephone number in response to the call;
obtaining a destination telephone number from the customer;
billing the call to the destination telephone number as coming from predetermined other telephone number, whereby the calling party telephone number is not provided to the destination telephone number.

4. The method of any one of claims 1, 2, or 3 further comprising the steps of:
receiving customer identification information from the customer;
calling the destination telephone number;
providing the customer identification information to a party answering the destination telephone number;
accepting a response from the party as to whether the collect call will be accepted;
based on the response, in the event that the response is affirmative, connecting the calling party telephone number and the destination telephone number.

5. The method of claim 3 wherein the steps of obtaining and receiving are performed by a human operator.

6. The method of claim 3 wherein the step of obtaining is performed in response to pressing at least one key on a customer telephone, and the step of receiving the customer information is performed by recording information provided by the customer.

7. The method of claim 3 wherein the steps of providing and connecting are performed by a human operator.

8. The method of claim 3 wherein the providing is performed by playing a recording of at least some of the customer information, and the connecting is performed in response to pressing at least one key on a destination telephone.

9. The method of claims 1 or 3 wherein the predetermined other telephone number is a telephone number of the provider.

10. A method of telephone billing a collect call comprising the steps of:
providing a toll-free telephone number to a customer to access a provider in a toll-free call from a calling party telephone number;
receiving the originating telephone number in response to the toll-free call;
obtaining a destination telephone number from the customer;
receiving customer identification information from the customer;
calling the destination telephone number;
providing the customer identification information to a party answering the destination telephone number;
accepting a response from the party as to whether the collect call will be accepted;
based on the response, in the event that the response is affirmative, connecting the calling party telephone number and the destination telephone number; and
billing the call to the destination telephone number as coming from a predetermined other telephone number, whereby the calling party telephone number is not provided to the destination telephone number.

11. A method of telephone billing a collect call comprising the steps of:
providing a toll-free telephone number to a customer to access a provider in a toll-free call from a calling party telephone number;
receiving the originating telephone number in response to the toll-free all;
obtaining a destination telephone number from the customer;
receiving customer identification information from the customer;
calling the destination telephone number;
providing the customer identification information to a party answering the destination telephone number;
accepting a response from the party as to whether the collect call will be accepted;
based on the response, in the event that the response is affirmative, connecting the calling party telephone number and the destination telephone number; and
billing the call to the destination telephone number as coming from the calling party telephone number.

12. A method of telephone billing a collect call comprising the steps of:
providing a local telephone number to a customer to access a provider in a call from a calling party telephone number;
receiving the originating telephone number in response to the call;
obtaining a destination telephone number from the customer;
receiving customer identification information from the customer;
calling the destination telephone number;
providing the customer identification information to a party answering the destination telephone number;
accepting a response from the party as to whether the collect call will be accepted;
based on the response, in the event that the response is affirmative, connecting the calling party telephone number and the destination telephone number; and
billing the call to the destination telephone number as coming from a predetermined other telephone number, whereby the calling party telephone number is not provided to the destination telephone number.

13. The method of one of claims 10, 11, or 12 further comprising the step of setting up a temporary muted connection between the calling party and the destination prior to the step of connecting.
